(19) United States
(12) Patent Application Publication
(10) Pub. No.: US 2022/0128758 A1
(43) Pub. Date: Apr. 28, 2022

(54) DISPLAY DEVICE

(71) Applicants: Hefei BOE Display Technology Co., Ltd., Hefei (CN); BOE TECHNOLOGY GROUP CO., LTD., Beijing (CN)

(72) Inventors: Chaoyue WANG, Beijing (CN); Jianming LIU, Beijing (CN); Wei KANG, Beijing (CN); Lu NIU, Beijing (CN)

(21) Appl. No.: 17/486,355

(22) Filed: Sep. 27, 2021

(30) Foreign Application Priority Data
Oct. 23, 2020 (CN) 202011149964.4

(51) Int. Cl. F21V 8/00

(52) U.S. Cl. CPC G02B 6/0051; G02B 6/0058; G02B 6/0043

(57) ABSTRACT

The present disclosure provides a display device including: at least one display structure; a backlight structure configured to provide a light source for the display structure, the backlight structure includes the light source, a first light guide plate and at least one optical structure layer, the light source transmits light to the first light guide plate through a light incoming surface of the first light guide plate, the optical structure layer is located between the first light guide plate and the display structure, scattering particles are arranged in the optical structure layer, and light emitted from a light exiting surface of the first light guide plate uniformly irradiates to the display structure through the optical structure layer.

### CROSS-REFERENCE TO RELATED APPLICATIONS

The present application claims the priority of Chinese Patent Application NO. 202011149964.4, filed on Oct. 23, 2020, the contents of which are incorporated herein in their entirety by reference.

### TECHNICAL FIELD

The present disclosure relates to the field of display technology, and particularly relates to a display device.

### BACKGROUND

With development of display technology, types of display devices are increasing, for example, there are transparent display devices, double-sided display devices, and so on.

A display device in the related art at least includes a display panel, a light guide plate, a glass protection back plate, a light source, an optical film layer, and the like. However, due to a structural defect, the display device in the related art has a problem that a display luminance in a direction perpendicular to a display surface of the display device is different from that in a direction not perpendicular to the display surface of the display device, for example, there is an insufficient luminance at a front viewing angle and a relatively high luminance at a side viewing angle.

### SUMMARY

The present disclosure provides a display device including: at least one display structure; a backlight structure configured to provide a light source for the display structure, the backlight structure includes the light source, a first light guide plate and at least one optical structure layer, where the light source transmits light into the first light guide plate through a light incoming surface of the first light guide plate, the optical structure layer is located between the first light guide plate and the display structure, scattering particles are arranged in the optical structure layer, and light emitted from a light exiting surface of the first light guide plate uniformly irradiates towards the display structure through the optical structure layer.

In some implementations, the scattering particles have a refractive index different from a refractive index of the optical structure layer.

In some implementations, a surface of the first light guide plate on a side thereof away from the display structure has a dot structure, a density of dots of the dot structure proximal to the light source is less than a density of dots of the dot structure distal from the light source, and light reflected by the dot structure in the first light guide plate is emitted from the light exiting surface of the first light guide plate and directed to the display structure.

In some implementations, the optical structure layer is an organic glass layer or a transparent adhesive layer.

In some implementations, the optical structure layer is the organic glass layer.

In some implementations, the scattering particles each have a particle diameter ranging from 1 μm to 10 μm; a doping concentration of the scattering particles ranges from 0.1 wt % to 1.0 wt %.

In some implementations, the optical structure layer is the transparent adhesive layer configured to connect the light exiting surface of the first light guide plate with the display structure.

In some implementations, in a direction from the first light guide plate to the display structure, the transparent adhesive layer sequentially includes a first adhesive sub-layer, a second adhesive sub-layer, and a third adhesive sub-layer, a refractive index of the second adhesive sub-layer is different from a refractive index of the first adhesive sub-layer, and the refractive index of the second adhesive sub-layer is different from a refractive index of the third adhesive sub-layer.

In some implementations, the refractive index of the first adhesive sub-layer is the same as the refractive index of the third adhesive sub-layer.

In some implementations, the second adhesive sub-layer has a certain reflectivity.

In some implementations, the second adhesive sub-layer has a haze ranging from 0 to 25%.

In some implementations, the scattering particles are disposed in the first adhesive sub-layer and the third adhesive sub-layer, and no scattering particles are disposed in the second adhesive sub-layer.

In some implementations, the display structure is a transparent display structure, and the first light guide plate is formed of a transparent material.

In some implementations, the transparent adhesive layer includes two layers; the light exiting surface of the first light guide plate includes two surfaces of the first light guide plate oppositely arranged; the display structure includes a first display structure and a second display structure which are respectively fixedly connected with the two surfaces of the first light guide plate serving as the light exiting surface.

In some implementations, the scattering particles each have a particle diameter less than 100 nm; a doping concentration of the scattering particles ranges from 0.05 wt % to 0.5 wt %.

In some implementations, each display structure includes a lower polarizer on a side of the display structure proximal to the first light guide plate, the lower polarizer having a haze.

In some implementations, the haze of the lower polarizer ranges from 15% to 55%.

In some implementations, the display device further includes: a light reflecting structure layer arranged on a surface of the first light guide plate except the light incoming surface and the light exiting surface.

In some implementations, the first light guide plate is a rectangular plate, and the light incoming surface includes at least three side surfaces of the rectangular plate.

In some implementations, the scattering particles are selected from one or more of titanium oxide (TiO₂) particles, aluminum oxide (Al₂O₃) particles, sulfur dioxide (SO₂) particles.

### DESCRIPTION OF DRAWINGS

The accompanying drawings, which are included to provide a further understanding of the present disclosure and are incorporated in and constitute a part of this specification, illustrate embodiments of the present disclosure and together with the description serve to explain the present disclosure, but do not constitute a limitation of the present disclosure. In the drawings:

FIG. 1 is a schematic structural diagram of a display device according to an embodiment of the present disclosure;

FIG. 2 is a schematic structural diagram of a display device according to an embodiment of the present disclosure;

FIG. 3 is a schematic diagram illustrating light propagation through an optical structure layer of the display device shown in FIG. 2;

FIG. 4 is a schematic structural diagram of a display device according to an embodiment of the present disclosure; and

FIG. 5 is a schematic diagram illustrating light propagation of a first light guide plate of a display device according to an embodiment of the present disclosure.

### DESCRIPTION OF EMBODIMENTS

In order that those skilled in the art will better understand the technical solutions of the present disclosure, the following detailed description is given with reference to the accompanying drawings and the specific embodiments.

The present disclosure will be described in more detail below with reference to the accompanying drawings. Like elements are denoted by like reference numerals throughout the various figures. For purposes of clarity, the various features in the drawings are not drawn to scale. Moreover, certain well-known elements may not be shown in the figures.

Numerous specific details of the present disclosure, such as structures, materials, dimensions, processing techniques and technologies of components, are set forth in the following description in order to provide a more thorough understanding of the present disclosure. However, as will be understood by those skilled in the art, the present disclosure may be practiced without these specific details.

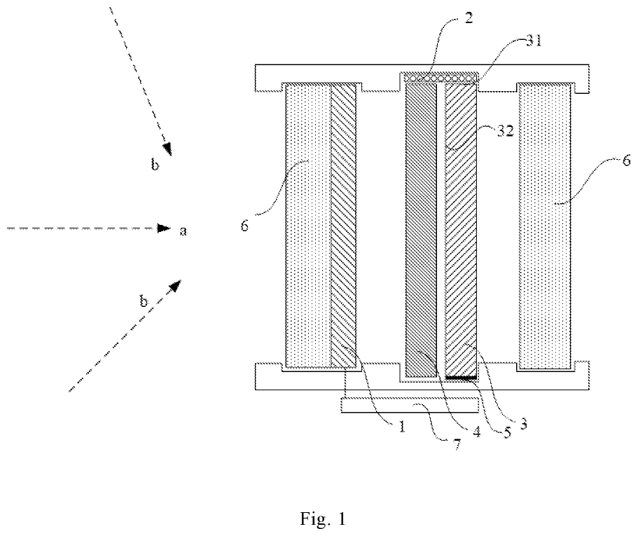

As shown in FIGS. 1 to 5, an embodiment of the present disclosure provides a display device including:

at least one display structure 1;

a backlight structure configured to provide a light source 2 for the display structure 1, and the backlight structure includes the light source 2 (such as an LED light bar), a first light guide plate 3, and at least one optical structure layer 4, where the light source 2 transmits light to the first light guide plate 3 through a light incoming surface 31 of the first light guide plate 3, the optical structure layer 4 is located between the first light guide plate 3 and the display structure 1, scattering particles 44 are disposed in the optical structure layer 4, and light emitted from a light exiting surface 32 of the first light guide plate 3 uniformly irradiates to the display structure 1 through the optical structure layer 4.

The display device of the embodiment sequentially includes the display structure 1, the optical structure layer 4, and the first light guide plate 3, and the light source 2 corresponds to the light incoming surface 31 of the first light guide plate 3, so that light emitted from the light source 2 sequentially passes through the first light guide plate 3 and the optical structure layer 4 and finally enters the display structure 1, so that the display structure 1 displays a picture.

When the light from the light source 2 enters the optical structure layer 4, the scattering particles 44 in the optical structure layer 4 can scatter the light to make the light emitted to the display structure 1 more uniform.

It should be noted that, in the display device of the related art, due to the structural defect thereof, the light emitted to the display structure 1 is not uniform, so that the display device has a problem that a display luminance in a direction perpendicular to a display surface of the display device is different from a display luminance in a direction not perpendicular to the display surface of the display device, for example, the display luminance in the direction perpendicular to the display surface (at the front viewing angle, as indicated by an arrow a in FIG. 1) is insufficient, and the display luminance in the direction not perpendicular to the display surface (at the side viewing angle, as indicated by an arrow b in FIG. 1) is relatively high, thereby greatly degrading user experiences.

In the display device of the embodiment, because the scattering particles 44 dispersed in the optical structure layer 4 are provided, the light emitted from the optical structure layer 4 to the display structure 1 is more uniform, and an inconsistency of display luminance at different viewing angles of the display device can be avoided, that is, the display luminance of the display device in the direction perpendicular to the display surface is consistent with the display luminance of the display device in the direction not perpendicular to the display surface, so as to improve a display performance of the display device and improve the user experiences.

Specifically, a refractive index of the scattering particles 44 is different from a refractive index of the optical structure layer 4.

In some implementations, the refractive index of the scattering particles 44 is greater than the refractive index of the optical structure layer 4.

The larger the difference between the refractive index of the scattering particles 44 and the refractive index of the optical structure layer 4, the better the scattering performance of the scattering particles 44 in the optical structure layer 4 on light.

In some implementations, a surface of the first light guide plate 3 on a side thereof away from the display structure 1 has a dot structure 33, and light reflected by the dot structure 33 in the first light guide plate 3 can exit from the light exiting surface 32 of the first light guide plate 3 and is directed to the display structure 1, as shown in FIG. 5.

Specifically, if the first light guide plate 3 does not have the dot structure 33, a portion of the light emitted to the first light guide plate 3 can only be totally reflected in the first light guide plate 3, and when the first light guide plate 3 has the dot structure 33, the light that would be originally totally reflected can be finally emitted from the light exiting surface 32 of the first light guide plate 3 by reflection of the dot structure 33.

That is, an arrangement of the dot structure 33 on the first light guide plate 3 not only can improve a light exiting efficiency from the first light guide plate 3, but also can make the light emitted from the first light guide plate 3 to the optical structure layer 4 more uniform.

In some implementations, a density of dots of the dot structure 33 proximal to the light source 2 is less than a density of dots of the dot structure 33 distal from the light source 2.

It should be noted that, if densities of dots of the dot structure 33 at different positions on the first light guide plate 3 are the same, the light emitted from the light exiting surface 32 of the first light guide plate 3 may not be uniform. Especially for a side-in type light guide plate, that is, when the first light guide plate 3 is a side-in type light guide plate, the light incoming surface 31 is a side surface thereof, and if the densities of dots of the dot structure 33 at different positions on the first light guide plate 3 are the same, the light emitted from a part of the light exiting surface 32 proximal to the light incoming surface 31 may be more than the light emitted from a part of the light exiting surface 32 distal from the light incoming surface 31, so that the light emitted from the first light guide plate 3 is not uniform, and the display luminance of the display structure 1 is not uniform.

In the embodiment, the densities of dots of the dot structure 33 at different positions on the first light guide plate 3 are different, so that the light emitted from the light exiting surface 32 of the first light guide plate 3 is more uniform, and an uniformity of the display luminance of the display device is further improved.

In addition, the scattering particles 44 dispersed in the optical structure layer 4 of the embodiment can avoid a display defect of moire fringes appearing in a display screen due to the dot structure 33 on the first light guide plate 3, or a display defect of moire fringes appearing in the display screen due to other structures.

In some implementations, the display device of the embodiment further includes: a light reflecting structure layer 5 disposed on a surface of the first light guide plate 3 except the light incoming surface 31 and the light exiting surface 32.

That is to say, the surface of the first light guide plate 3 except the light incoming surface 31 and the light exiting surface 32 can reflect light under an action of the light reflecting structure layer 5, so as to prevent light from exiting from other positions outside the light exiting surface 32, thereby improving an utilization rate of the light source 2.

In addition, the first light guide plate 3 may be a rectangular plate, and the light incoming surface 31 may include at least three side surfaces of the rectangular plate.

That is, the first light guide plate 3 may be a side-in type light guide plate, in which the light incoming surface 31 is a side surface thereof, and the light exiting surface 32 is a top surface or a bottom surface thereof. In some implementations, the first light guide plate 3 is a rectangular plate, and the light incoming surface 31 includes three side surfaces of the rectangular plate, that is, the three side surfaces all correspond to the light source 2, so that as much light as possible is incident into the first light guide plate 3, thereby improving the display luminance of the display device.

It should be noted that, a driving structure 7, such as an integrated circuit board or a flexible circuit board, may be disposed in a region corresponding to a side surface of the first light guide plate 3 except the side surfaces serving as the light incoming surface 31.

In some implementations, the optical structure layer 4 is an organic glass layer (e.g., PMMA polymer) or a transparent adhesive layer.

In some implementations, as shown in FIG. 1, the optical structure layer 4 is the organic glass layer.

Specifically, the display device includes the first light guide plate 3 and the optical structure layer 4, where the optical structure layer 4 may be equivalent to a second light guide plate.

The first light guide plate 3 may be a glass light guide plate, a transmittance of the glass light guide plate is relatively high, the dot structure 33 is designed according to optical simulation data, dots of the dot structure 33 proximal to the light source 2 each are relatively small and sparse, and dots of the dot structure 33 distal from the light source 2 each are relatively large and dense, so that the light exiting from the first light guide plate 3 is more uniform. In addition, a specific structure of the dot structure 33 may include a plurality of grooves or a plurality of protrusions on the first light guide plate 3, and the dot structure 33 may be prepared by a laser method.

The first light guide plate 3 and the optical structure layer 4 may be attached along a periphery thereof by a double-sided adhesive tape, or attached surface to surface by an optical adhesive material, or attached by a mechanical fixing, or attached by any other suitable fixing method.

In some implementations, the scattering particles 44 each have a particle diameter ranging from 1 μm to 10 μm; a doping concentration of the scattering particles 44 ranges from 0.1 wt % to 1.0 wt %.

Since the optical structure layer 4 may be made of organic glass, the doping process for doping the scattering particles 44 into the optical structure layer 4 is relatively mature, and the optical performance of the optical structure layer 4 finally formed is excellent. Specifically, the doping concentration may be 0.1 wt % to 1.0 wt % because too high doping concentration may cause the transmittance of the optical structure layer 4 to decrease, and may cause too much light emitted from a position proximal to the light source 2 and a dark region to be generated at a position distal from the light source 2. Further, the scattering particles 44 may be titanium oxide (TiO₂) particles (having a refractive index of 2.76), aluminum oxide (Al₂O₃) particles (having a refractive index of 1.76), sulfur dioxide (SO₂) particles (having a refractive index of 1.46), and since the higher the relative refractive index is at a same concentration, the higher the light scattering ability is, a particulate material having a relatively high refractive index may be selected for forming the scattering particles 44.

In some implementations, the display structure 1 is a transparent display structure, and the first light guide plate 3 is formed of a transparent material.

As can be seen from the above description, in some implementations, the display structure 1, the first light guide plate 3 and the optical structure layer 4 in the display device may be all transparent, that is, the display device is a transparent display device. For the transparent display device, the first light guide plate 3 may be a side-in type light guide plate, the light incoming surface 31 may include three side surfaces of the light guide plate, and the other side surface of the light guide plate except the side surfaces serving as the light incoming surface 31 may be provided with the light reflecting structure layer 5, so that the transparent display device may be a display device without a cavity (which is for reflecting light in the related art).

Meanwhile, the utilization rate of light of the transparent display device at the front viewing angle is greater than 65%; a luminance uniformity of the transparent display device is greater than 80%.

In addition, because the transparent display device has better light transmission, when ambient light is relatively strong, the ambient light can be used as the light source 2 of the display device, thereby simplifying the structure of the transparent display device and saving energy.

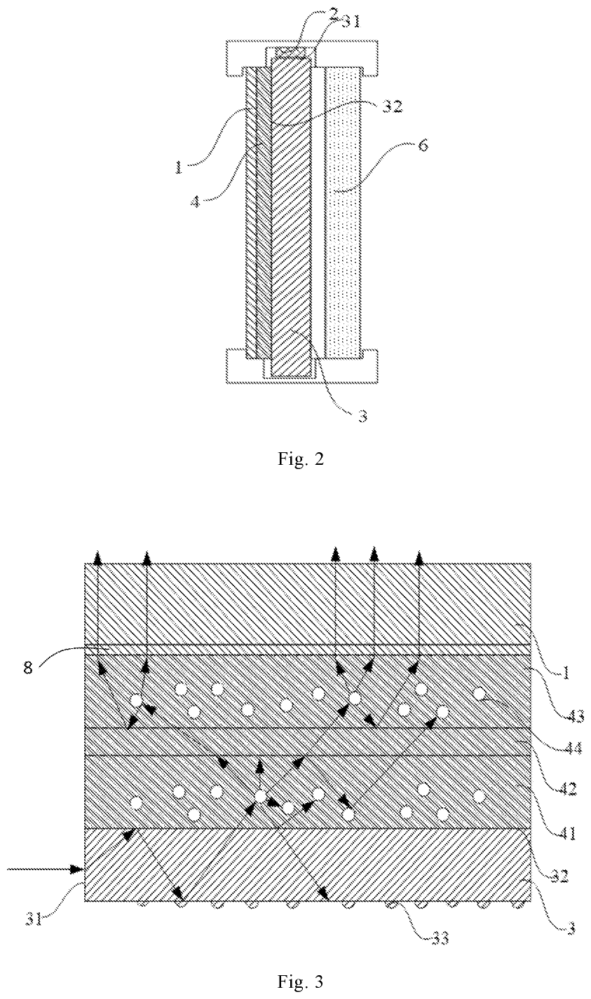

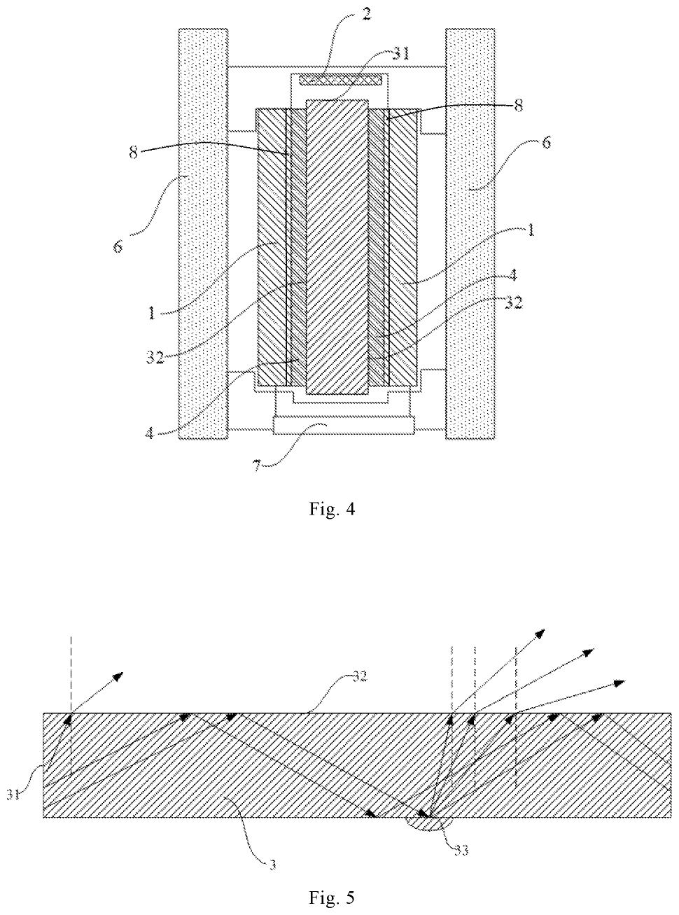

Further, as shown in FIG. 2 and FIG. 3, in some implementations, the optical structure layer 4 is the transparent adhesive layer, and is configured to connect the light exiting surface 32 of the first light guide plate 3 with the display structure 1.

Specifically, in a direction from the first light guide plate 3 to the display structure 1, the transparent adhesive layer may include in proper order: a first adhesive sub-layer 41, a second adhesive sub-layer 42 and a third adhesive sub-layer 43, a refractive index of the second adhesive sub-layer 42 is different from a refractive index of the first adhesive sub-layer 41, and the refractive index of the second adhesive sub-layer 42 is different from a refractive index of the third adhesive sub-layer 43.

Because the refractive index of the second adhesive sub-layer 42 is different from the refractive index of the first adhesive sub-layer 41 and the refractive index of the third adhesive sub-layer 43, a propagation direction of light is changed when the light propagates through interfaces between the adhesive sub-layers, and further due to a scattering effect of the scattering particles 44 in the transparent adhesive layer, the light emitted to the display structure 1 is more uniform.

In some implementations, the refractive index of the first adhesive sub-layer 41 is the same as the refractive index of the third adhesive sub-layer 43. The first adhesive sub-layer 41 and the third adhesive sub-layer 43 may be formed of an OCA (optical transparent adhesive) adhesive material, or may be formed of any other suitable optical adhesive material.

In addition, the second adhesive sub-layer 42 may have a certain reflectivity, and light emitted from the third adhesive sub-layer 43 to the second adhesive sub-layer 42 is reflected at an interface therebetween, so that the light is reflected back into the third adhesive sub-layer 43 and reflected into the display structure 1, and finally emitted out through the display structure 1, thereby further improving the uniformity of the light. Similarly, the light emitted from the first adhesive sub-layer 41 to the second adhesive sub-layer 42 is reflected at an interface therebetween, so that the light is reflected back into the first adhesive sub-layer 41 or the first light guide plate 3, and the light can be transmitted for a second time and finally emitted out through the display structure 1, thereby further improving the utilization rate of light. The reflectivity of the second adhesive sub-layer 42 may range from 5% to 20%.

The second adhesive sub-layer 42 may also have a certain haze, the second adhesive sub-layer 42 having the haze can further avoid a display defect of moire fringes appearing in the display screen caused by the dot structure 33 on the first light guide plate 3, or a display defect of moire fringes appearing in the display screen caused by other structures, and the like, and the haze of the second adhesive sub-layer 42 may range from 0 to 25%, and a thickness of the second adhesive sub-layer 42 may range from 75 μm to 150 μm. In addition, transmittances of the first adhesive sub-layer 41 and the third adhesive sub-layer 43 each may be greater than 90%.

The second adhesive sub-layer 42 may be formed of a Polyethylene terephthalate adhesive (PET) material, or any other suitable optical adhesive material.

As shown in FIG. 3, a propagation process of light in the display device of the embodiment of the present disclosure is specifically as follows: a part of the light emitted from the light source 2 to the light incoming surface 31 of the first light guide plate 3 is totally reflected in the first light guide plate 3 and propagates in a direction away from the light source 2, and another part of the light emitted from the light source 2 to the light incoming surface 31 of the first light guide plate 3 enters the first adhesive sub-layer 41 due to the dot structure 33. The light entering the first adhesive sub-layer 41 is scattered in various directions by the scattering particles 44, and is refracted and reflected at the interface between the first adhesive sub-layer 41 and the second adhesive sub-layer 42.

The light reflected at the interface between the first adhesive sub-layer 41 and the second adhesive sub-layer 42 is again scattered by the scattering particles 44 in the first adhesive sub-layer 41 and finally emitted to the display structure 1, so that the light is utilized. The light refracted at the interface between the first adhesive sub-layer 41 and the second adhesive sub-layer 42 sequentially enters the second adhesive sub-layer 42 and the third adhesive sub-layer 43, and under the action of the scattering particles 44 in the third adhesive sub-layer 43, a part of the light is emitted to the display structure 1, and another part of the light is emitted to the first light guide plate 3 and finally emitted to the display structure 1, so that the light is utilized.

In some implementations, the display structure 1 includes a lower polarizer (POL) 8 located at a side of the display structure 1 proximal to the first light guide plate 3, and the lower polarizer 8 may have a haze.

The lower polarizer 8 may have a certain haze, the lower polarizer 8 having the haze can further avoid a display defect of moire fringes appearing in the display screen caused by the dot structure 33 on the first light guide plate 3, or a display defect of moire fringes appearing in the display screen caused by other structures, and the like, and the haze of the lower polarizer 8 may range from 15% to 55%.

In some implementations, the display structure 1 is a transparent display structure 1, and the first light guide plate 3 is formed of a transparent material.

As can be seen from the above description, in some implementations, the display structure 1, the first light guide plate 3 and the optical structure layer 4 in the display device may all be transparent, that is, the display device may be a transparent display device.

It should be noted that the first light guide plate 3, the first adhesive sub-layer 41, the second adhesive sub-layer 42, the third adhesive sub-layer 43 and the display structure 1 may be fully attached surface to surface, that is, no bubbles exist between surfaces thereof attached. Therefore, the display device can be an integrated ultrathin transparent display device.

Further, as shown in FIG. 4, in some implementations, the optical structure layer 4 is a transparent adhesive layer, and is configured to connect the light exiting surface 32 of the first light guide plate 3 with the display structure 1, and the transparent adhesive layer may include two layers; the light exiting surface 32 of the first light guide plate 3 may include two surfaces of the first light guide plate 3 oppositely arranged; the display device may include two display structures 1 (a first display structure and a second display structure) respectively fixedly connected to the two surfaces of the first light guide plate 3 serving as the light exiting surface 32.

That is to say, the two surfaces of the first light guide plate 3 serving as the light exiting surface 32 each are connected to the transparent adhesive layer and the display structure 1, and the first light guide plate 3 can provide the light source 2 to the two display structures 1 simultaneously, so that the two display structures 1 display simultaneously, thereby realizing a double-sided display of the display device.

Compared with a double-sided display device (having a back plate (i.e., back light unit, BLU) and two light guide plates respectively providing light source for two display structures) in the related art, in a double-sided display device in the embodiment of the present disclosure, because the first light guide plate 3 can provide the light source 2 for the two display structures 1 simultaneously, the back plate (i.e., BLU) can be omitted, and the light guide plates can be reduced by one, so that the structure of the display device is simplified, and an ultrathin double-sided display device is formed.

In some implementations, in the double-sided display device, the scattering particles 44 in the transparent adhesive layer each have a particle diameter less than 100 nm; a doping concentration of the scattering particles 44 ranges from 0.05 wt % to 0.5 wt %.

The scattering particles 44 may be titanium oxide particles (having refractive index of 2.76), and since, at a same concentration, the higher the relative refractive index is, the higher the light scattering ability is, a particulate material having a relatively high refractive index may be selected for forming the scattering particles 44.

Since the larger the particle diameter of the scattering particles 44, the smaller the number of scattering particles 44 per unit volume, the smaller the number of scattering events in the light propagation path, and the lower the scattering ratio, while when the particle diameter of the scattering particles 44 is too large, it tends to cause uneven adhesion, therefore, the particle diameter of the scattering particles 44 is smaller than 100 nm.

When the doping concentration of the scattering particles 44 is too high, light is obviously attenuated in the transmission process, and the light propagation efficiency is reduced; meanwhile, the light scattering ability cannot be ensured by too low doping concentration, and thus, the doping concentration of the scattering particles 44 may range from 0.05 wt % to 0.5 wt %. In addition, a thickness of the transparent adhesive layer may range from 0.2 mm to 0.5 mm.

In some implementations, each display structure 1 may include a lower polarizer (POL) 8 on a side of the display structure 1 proximal to the first light guide plate 3, and the lower polarizer 8 may have a haze.

The lower polarizer 8 may have a certain haze, the lower polarizer 8 having the haze can further avoid a display defect of moire fringes appearing in the display screen caused by the dot structure 33 on the first light guide plate 3, or a display defect of moire fringes appearing in the display screen caused by other structures, and the like, and the haze of the lower polarizer 8 may range from 15% to 55%.

In some implementations, the first light guide plate 3 may have the dot structure 33 on both surfaces thereof serving as the light exiting surface 32.

The two surfaces of the first light guide plate 3, serving as the light exiting surface 32, with the dot structure 33 can not only improve the light exiting efficiency from the first light guide plate 3, but also make the light more uniformly emit from the first light guide plate 3 to two optical structure layers 4, so that the display luminance of the two display structures 1 can be consistent.

Furthermore, the display device may further include two transparent substrates 6, the display structure 1 and the backlight structure being located between the two transparent substrates 6.

It should be noted that the display structure 1 of the embodiment of the present disclosure may be a liquid crystal display panel, that is, the display device of the embodiment of the present disclosure may be a liquid crystal display device (LCD).

It should be noted that, in this document, relational terms such as first and second, and the like are used solely to distinguish one entity or action from another entity or action without necessarily requiring or implying any actual such relationship or order between such entities or actions. Also, the terms “include”, “comprise” or any other variation thereof, are intended to cover a non-exclusive inclusion, such that a process, method, article, or apparatus that contains a list of elements does not include only those elements but may include other elements not expressly listed or inherent to such process, method, article, or apparatus. Without further limitation, an element defined by the phrase “including an . . . ” does not exclude the presence of other identical elements in the process, method, article, or apparatus that contains the recited element.

In accordance with the embodiments of the present disclosure, as set forth above, these embodiments are not intended to be exhaustive or to limit the present disclosure to the precise embodiments described. Obviously, many modifications and variations are possible in light of the above teaching. The embodiments were chosen and described in order to best explain the principles of the present disclosure and the practical applications, to thereby enable others skilled in the art to better utilize the present disclosure and various embodiments with various modifications as are suited to the particular use contemplated. The present disclosure is to be limited only by the claims and their full scope and equivalents.

1. A display device, comprising:
at least one display structure;
a backlight structure configured to provide a light source for the display structure, the backlight structure comprises the light source, a first light guide plate and at least one optical structure layer, wherein the light source transmits light into the first light guide plate through a light incoming surface of the first light guide plate, the optical structure layer is located between the first light guide plate and the display structure, scattering particles are arranged in the optical structure layer, and light emitted from a light exiting surface of the first light guide plate uniformly irradiates towards the display structure through the optical structure layer.

2. The display device of claim 1, wherein a refractive index of the scattering particles is different from a refractive index of the optical structure layer.

3. The display device of claim 1, wherein a surface of the first light guide plate on a side thereof away from the display structure has a dot structure, a density of dots of the dot structure proximal to the light source is less than a density of dots of the dot structure distal from the light source, and light reflected by the dot structure in the first light guide plate exits from the light exiting surface of the first light guide plate and is directed to the display structure.

4. The display device of claim 1, wherein the optical structure layer is an organic glass layer or a transparent adhesive layer.

5. The display device of claim 4, wherein the optical structure layer is the organic glass layer.

6. The display device of claim 5, wherein the scattering particles each have a particle diameter ranging from 1 μm to 10 μm; a doping concentration of the scattering particles ranges from 0.1 wt % to 1.0 wt %.

7. The display device of claim 4, wherein the optical structure layer is a transparent adhesive layer configured to connect the light exiting surface of the first light guide plate with the display structure.

8. The display device of claim 7, wherein in a direction from the first light guide plate to the display structure, the transparent adhesive layer sequentially comprises a first adhesive sub-layer, a second adhesive sub-layer and a third adhesive sub-layer, a refractive index of the second adhesive sub-layer is different from a refractive index of the first adhesive sub-layer, and the refractive index of the second adhesive sub-layer is different from a refractive index of the third adhesive sub-layer.

9. The display device of claim 8, wherein the refractive index of the first adhesive sub-layer and the refractive index of the third adhesive sub-layer are the same.

10. The display device of claim 8, wherein the second adhesive sub-layer has a certain reflectivity.

11. The display device of claim 8, wherein the second sub-glue layer has a haze ranging from 0 to 25%.

12. The display device of claim 8, wherein the scattering particles are provided in the first adhesive sub-layer and the third adhesive sub-layer, and no scattering particles are provided in the second adhesive sub-layer.

13. The display device of claim 4, wherein the display structure is a transparent display structure, and the first light guide plate is formed of a transparent material.

14. The display device of claim 7, wherein the transparent adhesive layer comprises two layers; the light exiting surface of the first light guide plate comprises two surfaces of the first light guide plate oppositely arranged; the display structure comprises a first display structure and a second display structure which are respectively fixedly connected with the two surfaces of the first light guide plate serving as the light exiting surface.

15. The display device of claim 14, wherein the scattering particles each have a particle diameter less than 100 nm; a doping concentration of the scattering particles ranges from 0.05 wt % to 0.5 wt %.

16. The display device of claim 1, wherein each display structure comprises a lower polarizer on a side of the display structure proximal to the first light guide plate, the lower polarizer having a haze.

17. The display device of claim 16, wherein the haze of the lower polarizer ranges from 15% to 55%.

18. The display device of claim 1, further comprising: a light reflecting structure layer arranged on a surface of the first light guide plate except the light incoming surface and the light exiting surface.

19. The display device of claim 1, wherein the first light guide plate is a rectangular plate, and the light incoming surface comprises at least three side surfaces of the rectangular plate.

20. The display device of claim 1, wherein the scattering particles are selected from one or more of titanium oxide (TiO₂) particles, aluminum oxide (Al₂O₃) particles, sulfur dioxide (SO₂) particles.
